(19) United States
(12) Patent Application Publication
(10) Pub. No.: US 2020/0298115 A1
(43) Pub. Date: Sep. 24, 2020

(54) System and Method for Providing an Immersive Educational Experience

(71) Applicant: Omer Liran, Studio City, CA (US)

(72) Inventor: Omer Liran, Studio City, CA (US)

(21) Appl. No.: 16/358,058

(22) Filed: Mar. 19, 2019

(51) Int. Cl. A63F 13/53; G09B 23/28; A63F 13/428

(52) U.S. Cl. CPC A63F 13/53; G09B 23/28; A63F 2300/8082; A63F 2300/303; A63F 2300/8094; A63F 13/428

(57) ABSTRACT

A system and method for providing an immersive educational experience is provided. The system comprises a computing device, a head-mount display device, and in some embodiments, a handheld controller. The computing device is operative to store multimedia information, which comprises at least one graphical image and audio data. The graphical image is a three-dimensional representation of one or more biological mechanisms. In certain embodiments, the biological mechanisms include a white blood cell engulfing a human immunodeficiency virus (HIV), a white blood cell undergoing apoptosis, and a pharmaceutical compound shielding the cell from the virus. The head-mount display device is configured to be worn on the user's head and is operative to determine the position and orientation of the user's head, receive and display the immersive environment. In this manner, the system and method provided engage the user, improve the user's learning outcomes, and ultimately, improve the user's adherence to a medical treatment regime, such as that required by highly active antiretroviral therapy (HAART).

### GOVERNMENT CONTRACT

Not applicable.

### CROSS-REFERENCE TO RELATED APPLICATIONS

Not applicable.

### STATEMENT RE FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to systems and methods for providing immersive educational experiences and, more particularly, to a system and method for providing an educational experience utilizing virtual or augmented reality and which improves information retention and ultimately, adherence to a medical treatment regime by a user.

### BACKGROUND

According to the United States Center for Disease Control and Prevention (CDC), human immunodeficiency virus (HIV) weakens infected individuals' immune systems by destroying important cells that fight disease and infection. More specifically, HIV is inserted into white blood cells, makes copies of itself, then causes the white blood cell to burst, or undergo apoptosis. As a result, HIV is a very serious medical illness with significant morbidity and mortality. Following the discovery of the disease in 1981, a variety of pharmaceutical therapies utilizing a single drug was introduced to HIV-positive patients. However, these monotherapies proved ineffective in slowing the virus' progression as the HIV retains the ability to quickly develop resistance to single-drug treatments.

Advances in treatment have continued to progress with improved regimens, both in terms of efficacy, tolerability, and convenience. One such treatment, known as highly active antiretroviral therapy (HAART), involves a customized combination of multiple classes of medications known to be effective at treating HIV. Some of such classes of medications include enzyme inhibitors, which block enzymes that HIV needs to reproduce itself; fusion inhibitors, which block HIV from entering CD4 cells; and receptor antagonists, which block receptors on the surface of CD4 cells, thereby disallowing HIV to bind and enter these cells. In devising a HAART strategy, physicians prescribe particular medicines based on such factors as the patient's viral load, that is, how much virus is in the blood, the particular viral strain, the CD4 cell count, and other considerations, such as patient symptoms.

HAART adherence has been shown to be correlated with both survival and efficacy, including a decrease in viral loads. Indeed, an adherence rate of at least 90% to 95% is desirable as treatment efficacy has been shown to be highly correlated therewith. Nonadherence to HAART is a serious, unsolved problem. Reports have shown that approximately 40% of HIV-positive patients have HAART adherence rates below 90%. Health literacy has proven to be an independent predictor of HAART adherence. Thus, there remains a need for a system and method to improve health literacy in HIV, and other diseased, patients, in order to improve adherence to HAART, and other forms of treatment regimes.

Meanwhile, virtual reality (VR) and augmented reality (AR) have recently emerged as effective tools in several branches of medicine and education. Virtual reality provides an interactive computer-generated experience which allows a user to experience first-person presence within a simulated, virtual environment. Augmented reality similarly involves a simulated experience but dissimilarly incorporates real-world objects that are augmented by computer-generated information. VR and AR have been shown to improve learning outcome gains in both children and adults. As such, there exists a need to utilize these emerging immersive technologies in order to health and medicine information retention and ultimately, adherence to HAART, or another medical treatment regime, by a user.

### SUMMARY

The present disclosure is directed to a system and method for providing an immersive educational experience, which enhances learning outcomes, engages the attention of a user, and ultimately, improves adherence to a treatment regime. For purposes of brevity, the system and method for providing an immersive educational experience featuring virtual or augmented reality is shown and described, however, it will be understood that “immersive reality” or an “immersive experience” may include virtual reality, augmented reality, or even, mixed or merged reality.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

An immersive reality system is provided that may utilize a computing device and a head-mount display device, which may allow a user to view multimedia information consisting of at least one graphical image and audio data, and wherein the graphical image may be a three-dimensional representation of one or more biological mechanisms, said biological mechanisms being relevant to the user's pre-existing medical condition. Further, the user may perform actions by physically manipulating a handheld controller within an immersive environment defined by the multimedia information. As mentioned above, the immersive environment may utilize virtual reality, augmented reality, or mixed reality. The immersive environment may be displayed to the user via the head-mount display device, which may allow the user to witness the multimedia information while maintaining first person presence within the immersive environment.

In some embodiments, the at least one graphical image of the multimedia information may comprise the one or more biological mechanisms. The one or more biological mechanisms may further comprise one or more physiological agents and one or more treatment agents. The one or more physiological agents may illustrate cells, viruses, bacteria, or other naturally-occurring biological particles. On the other hand, the one or more treatment agents may illustrate pharmaceutical compounds or other forms of medical treatment.

For example, the one or more physiological agents may comprise a white blood cell and a human immunodeficiency virus (HIV). In such embodiments, the HIV may be visualized entering the white blood cell, copying itself, and causing the white blood cell to explode or undergo apoptosis. In this way, the immersive environment may depict the one or more biological mechanisms, such as that occurring in a diseased state, including, for example, a user with HIV infection or acquired immunodeficiency syndrome (AIDS), as discussed above. Additionally, in further embodiments, the immersive environment may depict a medicated state, such as the treatment agent healing or otherwise mitigating the effects of disease. For example, in the biological mechanism discussed above, the treatment agent may be an enzyme inhibitor, a fusion inhibitor, a receptor antagonist, or combination thereof, all of which may shield or otherwise protect against the effects the HIV may have on the white blood cell. One of ordinary skill in the art will understand that infinite other biological mechanisms may be depicted in this manner, including those occurring in a healthy state. The multimedia information may be stored in the computing device.

Defined by the multimedia information, the immersive environment may be generated by the computing device. Indeed, the computing device may be operative to adapt the appearance and events occurring within the immersive environment in accordance with the multimedia information. Moreover, the computing device may be operative to transmit output data defined by the immersive environment. In some embodiments, the immersive environment may be an augmented environment, which may be defined by a real space and the multimedia information. The real space may comprise objects and dimensions existing in the real world and with which the multimedia information may co-exist in the augmented environment. In such embodiments, the computing device may be operative to transmit the output data defined by the augmented environment.

Responsive to the output data transmitted by the computing device, the head-mount display device may be operative to receive the output data. Additionally, the head-mount display device may be configured to be worn on the user's head and may also be operative to determine the position and orientation of the user's head. Further, the head-mount display device may display the immersive environment according to the position and orientation of the user's head and the output data. In particular, the head-mount display device may be operative to display the at least one graphical image and deliver the audio data to the user. In this way, the head-mount display device may further comprise a visual display and at least one audio emitter. In other embodiments, the system may further comprise a monitor, separate from the head-mount display device, which may display the at least one graphical image and transmit the audio data to the user. In still other embodiments, the system may comprise an audio speaker, separate from the head-mount display device and the monitor, which may be operative to transmit the audio data to the user.

In some embodiments, the head-mount display device may further comprise one or more sensors to, which may be capable of measuring positional information about the user's head and a surrounding real space and communicating this positional information to the head-mount display device. In some of these embodiments, the head-mount display device may be further operative to emit signals relaying the positional information. In further embodiments, the system may further comprise one or more sensor stations, which may be operative to sense the signals emitted from the head-mount display device.

In certain embodiments, the computing device may be further operative to receive input data transmitted by the handheld controller and adapt the immersive environment in accordance with the input data. In such embodiments, the user may be able to interact with the immersive environment. For instance, the user may interact with the one or more physiological agents and the one or more treatment agents. More specifically, the user may cause the one or more treatment agents to act on the one or more physiological agents in the immersive environment. In further embodiments, the user may move or manipulate the one or more physiological agents or the one or more treatment agents in order to reveal more information about the underlying biological mechanism.

The handheld controller may take many forms, such as a keyboard, a mouse, a joystick, a throttle, or other computer controller known in the art. Indeed, the handheld controller may have one or more input devices, such as a button, switch, or trigger, which the user may physically manipulate by actuating, such as pressing the button. In some embodiments, the handheld controller itself may be moved by the user within the real-world space. Upon the receipt of physical manipulations by the user, the controller may measure the manipulations, thereby generating input data. In other embodiments, when the one or more input devices are actuated by the user, the handheld controller may be further operative to provide force feedback to the user.

In one embodiment of the present invention, a computer-implemented method may be used to facilitate provision of the immersive educational experience to the user by the user wearing the head-mount display device. The method may comprise the steps of providing a computing device and the head-mount display device; at the computing device, generating an immersive environment; at the computing device, transmitting the immersive environment to the head-mount display device; and at the head-mount display device, determining the position and orientation of the user's head and delivering the immersive environment to the user.

Initially, the immersive environment may be defined by multimedia information and, in turn, the multimedia information may comprise at least one graphical image and audio data. The graphical image may comprise a three-dimensional representation of one or more biological mechanisms, which may comprise one or more physiological agents and one or more treatment agents. For instance, as discussed above, the one or more physiological agents may comprise a real-world cell and the one or more treatment agents may comprise a real-world pharmaceutical compound. In embodiments wherein the immersive environment may be a virtual reality environment, the immersive environment may be defined solely by the multimedia information. In embodiments wherein the immersive environment may be an augmented reality environment, the immersive environment may be defined by the multimedia information and a real space.

As generated, the immersive environment may be delivered to the user wearing the head-mount display device. Also, the head-mount display device may determine the position and orientation of the user's head relative to the real space and adapt the display accordingly so as to simulate a real-world experience for the user in the immersive environment. For example, if the user tilts his or her head to the side in the real space, the head-mount display device may similarly adjust so as to provide a corresponding point of view of the immersive environment.

In further embodiments, a handheld controller may receive and measure physical manipulations by the user. When the user physically manipulates the handheld controller, the handheld controller may transmit input data, which may be defined by the physical manipulations, to the computing device. In turn, the computing device may receive the input data from the handheld controller and may alter the immersive environment in response to the input data. Indeed, the handheld controller may thereby control the immersive environment, including the one or more graphical images. When the one or more graphical images may be controlled in this manner, the corresponding audio data may be delivered to the user via the head-mount display device. The immersive environment may be delivered to the user via the head-mount display device and may be updated in real-time in accordance with physical manipulations of the handheld controller by the user.

In still further exemplary embodiments, the computing device may generate the one or more physiological agents comprising a white blood cell, the one or more physiological agents comprising a human immunodeficiency virus (HIV), and the one or more treatment agents. In these embodiments, the head-mount display device may then display the white blood cell engulfing the HIV and then, the white blood cell undergoing apoptosis as a result. In this way, the user may learn about biology and more specifically, the biology underlying an HIV infection.

In other embodiments, the computing device may generate the one or more physiological agents comprising a white blood cell, the one or more physiological agents comprising a human immunodeficiency virus (HIV), and the one or more treatment agents. In such embodiments, the head-mount display device may display the one or more treatment agents shielding the white blood cell and then, the HIV unsuccessfully attempting to attack the white blood cell. In this manner, the user may learn about the importance of adhering to a medical treatment regime, including timely ingestion of prescribed medications.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 illustrates an embodiment of a system for providing an immersive educational experience.

FIG. 2 is a flowchart depicting an exemplary method of providing an immersive educational experience.

FIG. 3 is a flowchart depicting an exemplary method of providing an immersive educational experience

FIG. 4 is a flowchart depicting an exemplary method of providing an immersive educational experience

FIG. 5 is a flowchart depicting an exemplary method of providing an immersive educational experience.

FIG. 6 is a block diagram illustrating an exemplary embodiment of a computing device configured to implement the system and method.

FIG. 7 is a block diagram illustrating an exemplary embodiment of a head-mount display device configured to implement the system and method.

FIG. 8 is a block diagram illustrating an exemplary embodiment of a handheld controller configured to implement the system and method.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A system and method for providing an immersive educational experience is provided that, in some embodiments, may permit a real-world user to learn about one or more naturally-occurring biological mechanisms, including a diseased state, and medical treatments that can counteract those mechanisms. The system and method may feature virtual reality or augmented reality. However, the term “immersive reality” is used throughout the remainder of this disclosure and should be understood to include virtual reality, augmented reality, and mixed or merged reality. The system and method may permit the user to feel present in an immersive environment as a first person and to witness and control actions of the one or more biological mechanisms. Indeed, to do so, the system and method may comprise a computing device, a head-mount display device, and in some embodiments, a handheld controller.

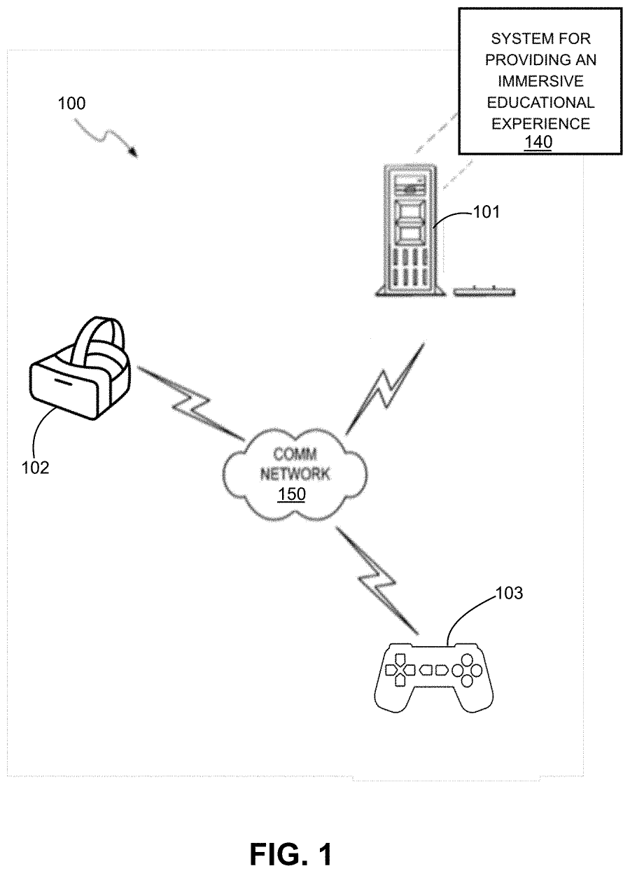

FIG. 1 is illustrative of a networked environment 100 in which an embodiment of a system for providing an immersive educational experience 140 is implemented. As shown in FIG. 1, the system 140 may comprise a plurality of electronic devices. By way of example, and not limitation, a computing device 101, a head-mount display device 102, and a handheld controller 103 are shown communicatively coupled via a communication network 150. Notably, the communications network 150 may use one or more of various communications types such as, for example and without limitation, wired, cellular, and Wi-Fi communications. Moreover, each of the computing device 101, the head-mount display device 102, and the handheld controller 103 may be coupled to a power supply. This may be effectuated by way of a power cord, battery, or other means of supplying electrical power as may be available or otherwise desired.

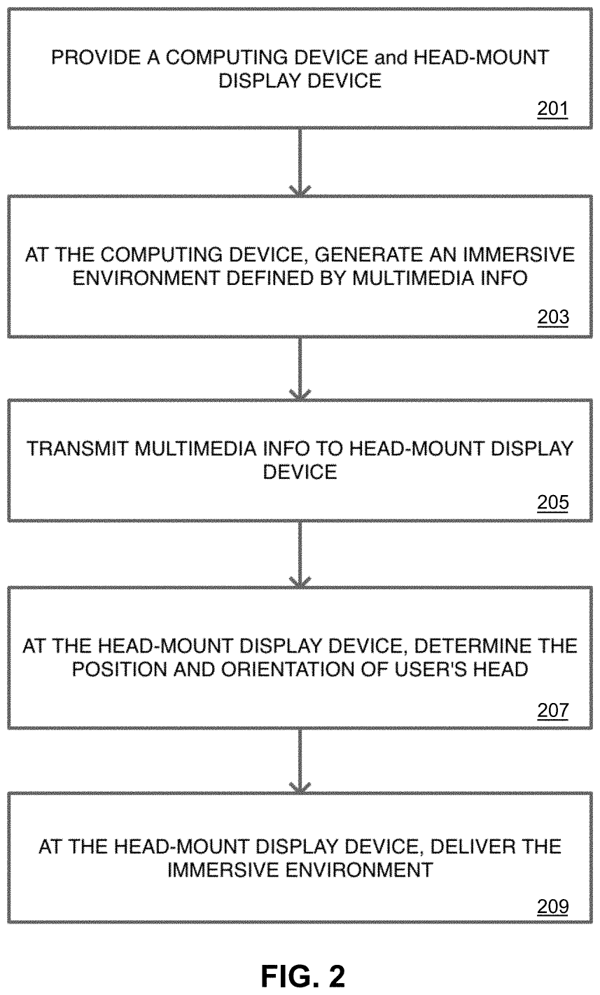

In order to facilitate the aforementioned functionality, various aspects may be performed by one or more of the electronic devices 101, 102, and 103. In one embodiment, the electronic devices are operative to perform, at least in part, the method depicted in the flowcharts of FIGS. 2-5 and described below.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the computing device 101. The machine code may be converted from the source code, etc. If embodied in hardware, each block may represent a circuit or a number of interconnected circuits to implement the specified logical function(s).

In some embodiments, the computing device 101 may be operative to store multimedia information, which may define the immersive environment. The multimedia information may thereby be generated by and retrievable from the computing device 101 and may comprise at least one graphical image and audio data. In alternate embodiments, the multimedia information may be stored on and retrievable from a separate server. The computing device 101 may adapt the immersive environment in accordance with the multimedia information.

In certain exemplary embodiments, as mentioned above, the immersive environment may be an augmented environment, which may utilize augmented reality. The augmented environment in these embodiments may be defined by a real space and the multimedia information. The real space may comprise real-world objects and environments and the multimedia information may co-exist within the augmented environment. In such embodiments, the output data transmitted by the computing device 101 may be defined by the augmented environment.

The multimedia information may further comprise elements and features already known in the art. Moreover, the multimedia information may comprise novel elements and features not known in the art. A person of ordinary skill in the art will recognize numerous types of educational experiences may be adapted in accordance with this invention. The at least one graphical image may further comprise a three-dimensional representation of the one or more biological mechanisms, as mentioned above.

In certain embodiments, the one or more biological mechanisms may variously comprise one or more physiological agents and one or more treatment agents. The one or more physiological agents may illustrate a three-dimensional representation of a cell, a virus, a bacterium, or other naturally-occurring biological agent. The one or more treatment agents may illustrate a three-dimensional representation of a pharmaceutical compound or other medical treatment. In such embodiments, the computing device may generate the treatment agent acting upon the physiological agent.

One exemplary embodiment of the present invention may involve the one or more physiological agents comprising a white blood cell and a human immunodeficiency virus (HIV). In one such embodiment, the biological mechanism may involve and depict the biology underlying a diseased state, such as an HIV infection. In this manner, the HIV may attack the white blood cell and the HIV may use the white blood cell's functionalities to copy itself, thereby forming more than one HIV. In other such embodiments, the biological mechanism may involve and depict the biology underlying a medicated state, such as HIV pharmaceutical treatment. In particular, the one or more treatment agents may act upon the white blood cell so as to shield it from the HIV, thereby treating or mitigating the effects of an HIV infection. In these embodiments, the treatment agent may be an enzyme inhibitor, a fusion inhibitor, a receptor antagonist, or combination thereof.

In other embodiments, the biological mechanisms may comprise numerous other forms of physiological agents and numerous other forms of treatment agents. In some embodiments, the biological mechanism may involve and depict the biology underlying healthy cells. In other embodiments, the biological mechanism may involve and depict the biology underlying diseased cells, such as that discussed above with regard to an HIV infection. A person of ordinary skill in the art will appreciate that virtually any type of biological mechanism may be depicted in the immersive environment.

Further, while the above-mentioned embodiment describes the at least one graphical image as virtually tangible, the graphical image may also be virtually intangible. In embodiments where the at least one graphical image is virtually tangible, the graphical image may be the cell, virus, bacteria or other naturally-occurring biological agents discussed previously. In alternate embodiments where the graphical image may be virtually intangible, the graphical image may comprise educational information, such as information regarding the biological mechanism, a user choice, such as whether or not to administer medical treatment, a hint or trick, or a means to enter a different immersive environment.

As mentioned above, the multimedia information may also comprise the audio data. The audio data may comprise words, phrases, monologues, dialogues, or other units of language. The audio data may also comprise a hum, thud, thump, crash, jingle, jangle, swish, clatter, crunch, tinkle, vibration, reverberation, squawk, clank, clack, clash, creak, cough, swoosh, splash, screech, growl, snarl, slurp, roar, buzz, boom, hiss, purr, fizz, drip, flutter, groan, gurgle, rattle, sizzle, trumpet, tweet, chirp, or squeak. Moreover, the audio data may further comprise songs or musical tones. One of ordinary skill in the art will recognize other types of audio data may be possible in accordance with this invention. In some embodiments, the audio data may correspond to actions taken and events occurring within the immersive environment. In alternate embodiments, the audio data may remain constant and unaltered by events in the immersive environment. For example, in embodiments where the one or more audio data may comprise a song, said song may play constantly in the background.

The computing device may be further operative to transmit output data defined by the immersive environment. The head-mount display device 102 may be configured to be worn on a user's head. In some embodiments, the head-mount display device 102 may be one size fits all. In other embodiments, the head-mount display device 102 may be adjustable to fit. Also, the head-mount display device 102 may be operative to determine the position and orientation of the user's head in real-world space and receive the output data from the computing device 101. The head-mount display device 102 may be further operative to deliver the immersive environment to the user, in accordance with the position and orientation of the user's head and the output data. In certain embodiments, the head-mount display device 102 may be comprise the computing device. In such embodiments, the head-mount display device 102 may be operative to perform the above-described functions performed by the computing device. In some embodiments, the head-mount display device 102 may comprise one or more sensors, a visual display, and at least one audio emitter.

The one or more sensors may be operative to determine the position and orientation of the user's head. In certain embodiments, the system 140 may further comprise one or more sensor stations. In such embodiments, the head-mount display device 102 may be further operative to emit signals and the one or more sensor stations may be operative to sense the signals emitted therefrom. Upon sensing signals from the head-mount display device 102, the sensor stations may be operative to determine the position and orientation of the user's head and then may transmit this information to the head-mount display device 102. In certain embodiments, the sensor stations may be further operative to detect and measure the position, orientation, and gestures of the user's hands and body. In these embodiments, no handheld controller may be necessary as the sensor stations may track the user's movements so as to correlate those movements to on-screen events and actions. The sensor stations may therefore be operative to communicate with the head-mount display device 102 via the communication network 150 and may be coupled to a power supply, such as those discussed above.

The visual display of the head-mount display device 102 may render the immersive environment, and more particularly, the graphical images, in a manner visible to the user. The visual display may be variously formed out of a liquid crystal display panel, a light emitting diode screen, an organic light emitting diode screen, an electrophoretic display, a cathode ray tube, a liquid crystal on silicon, a plasma panel display, a virtual retinal display, or a combination of the aforementioned materials. A person of ordinary skill in the art will recognize the head-mount display device 102 may comprise any other types of display technologies known to those in the art. The head-mount display device 102 may be operative to incorporate the information from the sensors or sensor stations, as the case may be, regarding the position and orientation of the user's head and generate the visual display so as to alter the perspective from which the user views the immersive environment. Indeed, the visual display may be adjusted as the positional information is updated. In certain embodiments, the visual display may be adapted in real time as the positional information is updated.

In some embodiments, the system 140 may further comprise a monitor, which may be separate from the head-mount display device 102. The monitor may be operative to display the graphical images. In certain embodiments, the monitor may also reproduce the audio data to the user. The immersive environment as displayed by the monitor may mirror the visual display of the immersive environment visible to the user wearing the head-mount display device. In such embodiments, while one user may experience first-person presence within the immersive environment, more than one user may be able to observe and enjoy the experience simultaneously.

The audio emitter of the head-mount display device 102 may render the audio data in a manner audible to the user. In some embodiments, the audio emitter may reproduce audio data that is associated with the graphical images such that the sound produced is localized to the graphical images, thereby immersing the user in a realistic sound field. In other embodiments, the audio data may be reproduced so as to be unassociated with the graphical images. For instance, the audio data, as discussed above, may be a song constantly playing or even, ambient noise.

In alternate embodiments, the system 140 may further comprise an audio speaker, which may be separate from the head-mount display device 102. In some embodiments, the audio speaker may be contained within the monitor. In other embodiments, the audio speaker may also be separate from the monitor. The audio speaker may be operative to transmit the audio data to the user.

In embodiments wherein the system 140 further comprises the handheld controller 103, which may be operative to receive and measure physical manipulations thereof to define input data. The handheld controller 103 may also be operative to transmit the input data to the computing device 101. In such embodiments, the computing device 101 may be further operative to receive the input data transmitted by the handheld controller 103 and then adapt the immersive environment in accordance with the input data.

The handheld controller 103 may further comprise one or more input devices, which the user may physically manipulate by, for example, pushing, pulling, or otherwise actuating. The input devices may be buttons, switches, triggers, joysticks, trackballs, gamepads, paddles, throttle quadrants, steering wheels, yokes, pedals, handles, touchpads, touchscreens, keypads, image scanners or other similar devices known in the art. Moreover, the handheld controller 103 itself may be variously formed as a keyboard, a mouse, a joystick, or other computer controller known in the art.

In some embodiments, the user may physically manipulate the handheld controller 103 itself within the real space. For example, the user may thrust in a forward or reverse direction, rotate around an axis, or jostle the handheld controller 103. In other embodiments, the user may physically manipulate the input devices. The input devices may be actuated in a variety of ways and the manner of actuation may depend on the type and form of input device. For instance, in embodiments where the one or more input devices may include a button, the button may be actuated by the user exerting physical pressure thereon. As another example, in embodiments where the one or more input devices may include a joystick, the joystick may be pivoted around its base by the user.

In certain embodiments, the user may interact with the immersive environment by physically manipulating the handheld controller 103 or the one or more input devices thereon. More specifically, the user may interact with the graphical images. Additionally, in embodiments wherein the graphical images may be virtually intangible, the user may interact with the immersive environment by making a choice, accessing educational information, accessing a hint or trick, or entering a different immersive environment. For example, the user may interact with the one or more treatment agents by physically manipulating the handheld controller 103 in a corresponding manner and may thereby cause the one or more treatment objects to engage the one or more physiological agents within the immersive environment.

In alternate embodiments, the handheld controller 103 may be further operative to provide force feedback to the user. To this end, the handheld controller 103 may comprise a haptic driver operative to provide haptic effects. For example, upon actuation of an input device associated with making a choice in the immersive environment, if the choice is the “wrong” choice, the haptic driver may cause the handheld controller 103 to vibrate. On the other hand, if the choice is the “correct” choice, the haptic driver may cause the handheld controller 103 to provide a different type of haptic feedback so that the user may learn the difference between “correct” and “wrong” choices in the immersive environment. As another example, the handheld controller 103 may be operative to give the impression of weight or resistance. In yet further embodiments, the handheld controller 103 may further comprise one or more accelerometers or other positional sensors that may be capable of detecting the orientation, position, and acceleration of the handheld controller 103 in real-world space. Indeed, the handheld controller 103 may one or more comprise motion tracking sensors and may be further operative to measure sensed movements.

FIG. 2 is a flowchart depicting an exemplary embodiment of a system and method for providing an immersive educational experience, such as may be performed by the computing device 101 and the head-mount display device 102 of FIG. 1. As shown in FIG. 2, the method may include the steps of: providing a computing device and a head-mount display device (block 201); at the computing device, generating an immersive environment defined by multimedia information (block 203); at the computing device, transmitting the immersive environment to the head-mount display device (block 205); at the head-mount display device, determining the position and orientation of the user's head (block 207); and at the head-mount display device, delivering the immersive environment to the user (block 209).

Determining the position and orientation of the user's head (block 207) may further comprise securing the head-mount display device to the user's head and automatically scaling the X axis, the Y axis, and the Z axis of the immersive environment so as to be corresponding and proportionate to the position and orientation of the user's head in the real space. Moreover, as a function of the position and movement of the user's head within the real space, the immersive environment may be delivered to the user via the head-mount display device (block 209). Indeed, the head-mount display device may automatically adapt the immersive environment as displayed to the user to consider these movements and the user's point of view may be accordingly adjusted. In some embodiments, the Y axis of the immersive environment may remain fixed at a predetermined height so as to mimic the user's point of view in the immersive environment. In some embodiments wherein the Y axis is fixed, upon movement of the user's head in the real space, the user's point of view may track such movements along the X axis and Z axis of the immersive environment. In other embodiments wherein the Y axis is fixed, the user's point of view may be adjustable independent of movement of the user's head in the real space.

The multimedia information which defines the immersive environment may comprise at least one graphical image and audio data. The at least one graphical image may comprise a three-dimensional representation of one or more biological mechanisms. Further, the one or more biological mechanisms may further comprise one or more physiological agents and one or more treatment agents. In some embodiments, the immersive environment may be generated (block 203) so as to automatically comprise the one or more biological mechanisms, that is, the biological mechanism may be pre-selected. In other embodiments, the user may manually select the biological mechanism. In still other embodiments, the user may manually select one or more physiological agents and one or more treatment agents. Indeed, in such embodiments, the user may experiment with the interactions of the one or more physiological agents and the one or more treatment agents.

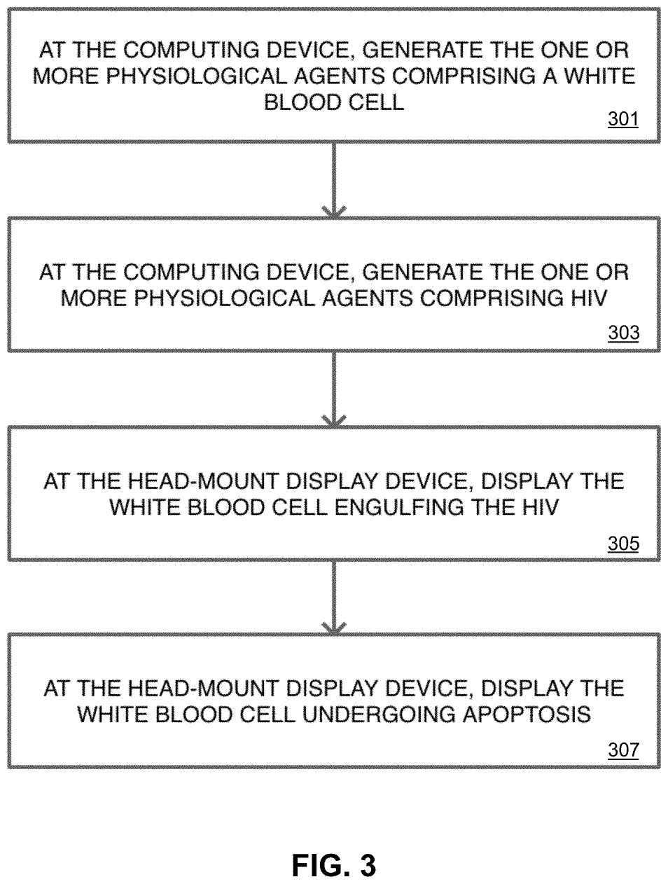

In certain exemplary embodiments, the one or more biological mechanisms may depict for the user the biology underlying an HIV infection or acquired immunodeficiency syndrome (AIDS). FIG. 3 is a flowchart depicting such exemplary embodiment of a system and method for providing an immersive educational experience. Such exemplary method may include the steps of: at the computing device, generating the one or more physiological agents comprising a white blood cell (block 301); at the computing device, generating the one or more physiological agents comprising a human immunodeficiency virus (HIV) (block 303); at the head-mount display device, displaying the white blood cell engulfing the HIV (block 305); and at the head-mount display device, displaying the white blood cell undergoing apoptosis (block 307).

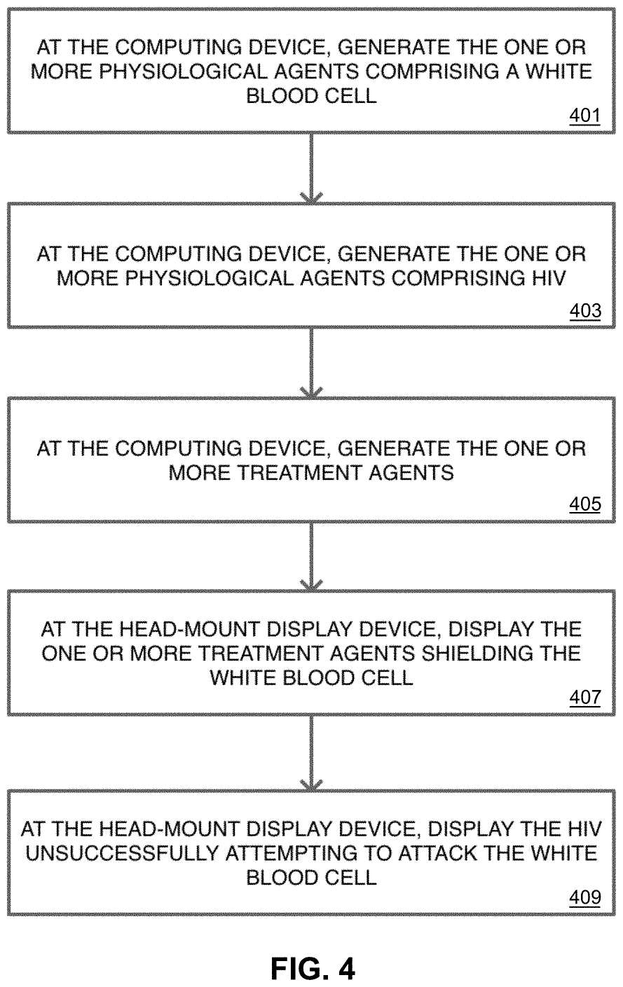

In alternate exemplary embodiments, the one or more biological mechanisms may depict for the user the biology underlying medical treatment for HIV or AIDS. FIG. 4 is a flowchart depicting such an exemplary embodiment, which may include the steps of: at the computing device, generating the one or more physiological agents comprising a white blood cell (block 401); at the computing device, generating the one or more physiological agents comprising a human immunodeficiency virus (HIV) (block 403); at the computing device, generating the one or more treatment agents (block 405); at the head-mount display device, displaying the one or more treatment agents shielding the white blood cell (block 407); and at the head-mount display device, displaying the HIV unsuccessfully attempting to attack the white blood cell (block 409).

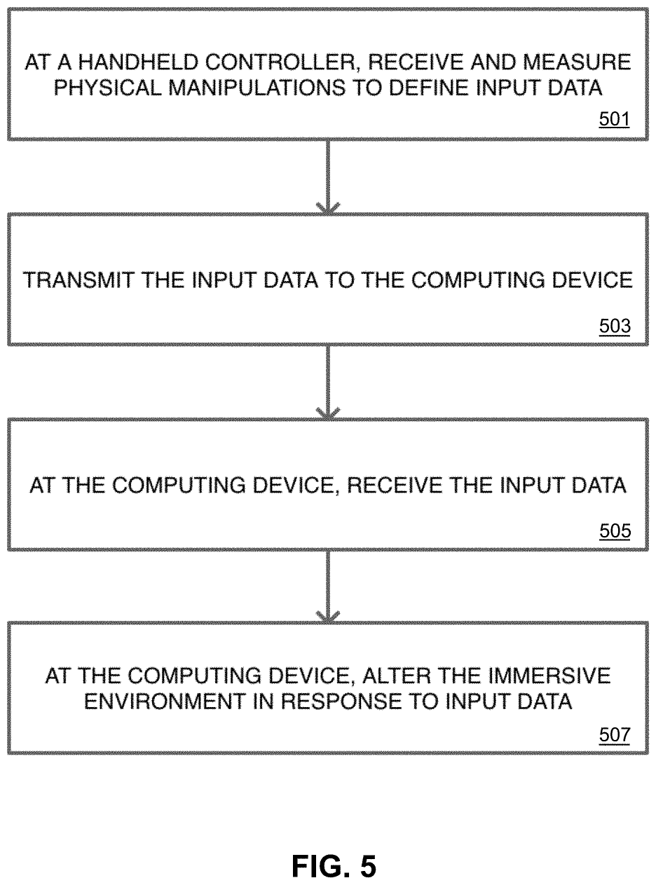

FIG. 5 is a flowchart depicting a further embodiment of a system and method for providing an immersive educational experience. In particular, the method may further include the steps of: at a handheld controller, receiving and measuring physical manipulations to define input data (block 501); at the handheld controller, transmitting the input data to the computing device (block 503); at the computing device, receiving the input data from the handheld controller (block 505); and at the computing device, altering the immersive environment in response to the input data (block 507).

Various types of physical manipulations of the handheld controller may be received and measured (block 501) in accordance with this invention. For instance, the handheld controller may be moved in an upward direction in the real space. The physical manipulations may then be processed by the computing device and the immersive environment may be accordingly adapted. Similarly, the handheld controller may be jostled back-and-forth by the user and subsequently, the computing device may adapt the immersive environment so as to move back-and-forth. Additionally, the handheld controller may comprise one or more input devices and the input devices may be directly physically manipulated by the user. In particular, the input devices may be pressed, pushed, or otherwise actuated. Upon such physical manipulations of the input devices, the computing device may process such manipulations and the immersive environment may then be adapted in accordance with such manipulations.

If embodied in software, it should be noted that each block depicted in the referenced flowcharts may represent a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the computing device 101, the head-mount display device 102, or the handheld controller 103. The machine code may be converted from the source code, etc. If embodied in hardware, each block may represent a circuit or a number of interconnected circuits to implement the specified logical function(s). Additionally, although the above flowcharts show specific orders of execution, it is to be understood that the orders of execution may differ.

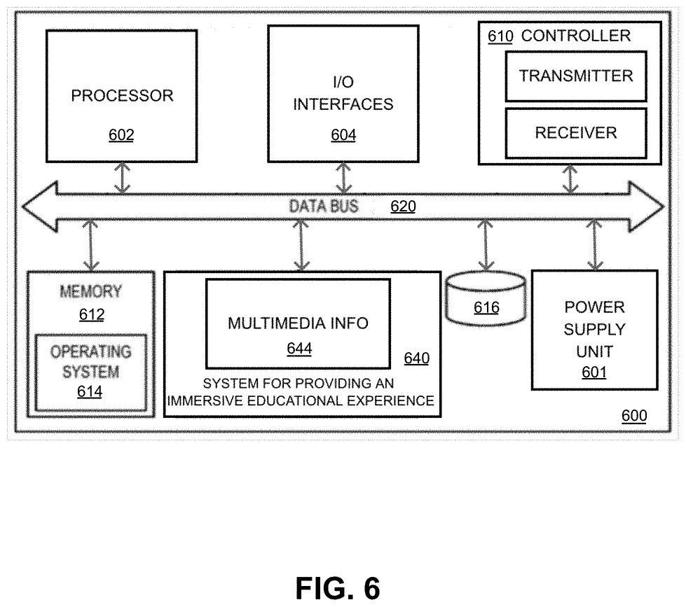

FIG. 6 illustrates an exemplary computing device 600 configured to implement the system for providing an immersive educational experience. Computing device 600 may be a desktop computer, laptop, gaming console, or even tablet computer but may also be embodied in any one of a wide variety of wired and/or wireless computing devices known to those skilled in the art. The computing device 600 may include a processing device (processor) 602, input/output interfaces 604, a controller 610 having a transmitter and receiver, a memory 612, and operating system 614, and a mass storage 616, with each communicating across a local data bus 620. Additionally, computing device 600 may incorporate a system 640 for providing an immersive educational experience and multimedia information 644 stored locally, although the location of information 644 could vary. The computing device 600 may further comprise a power supply 601.

The processor 602 may include any custom made or commercially available processor, a central processing unit (CPU) or an auxiliary processor among several processors associated with the computing device 600, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 612 can include any one of a combination of volatile memory elements (e.g., random-access memory (RAM, such as DRAM, and SRAM, etc.)) and nonvolatile memory elements. The memory typically comprises native operating system 614, one or more native applications, emulation systems, or emulated applications for any of a variety of operating systems and/or emulated hardware platforms, emulated operating systems, etc. For example, the applications may include application specific software which may comprise some or all the components of the computing device 600. In accordance with such embodiments, the components are stored in memory and executed by the processing device. Note that although depicted separately, the system 640 and the multimedia information 644 may be resident in memory such as memory 612.

One of ordinary skill in the art will appreciate that the memory 612 can, and typically will, comprise other components which have been omitted for purposes of brevity. Note that in the context of this disclosure, a non-transitory computer-readable medium stores one or more programs for use by or in connection with an instruction execution system, apparatus, or device. The controller 610 comprises various components used to transmit and/or receive data over a networked environment such as depicted in FIG. 1. When such components are embodied as an application, the one or more components may be stored on a non-transitory computer-readable medium and executed by the processor.

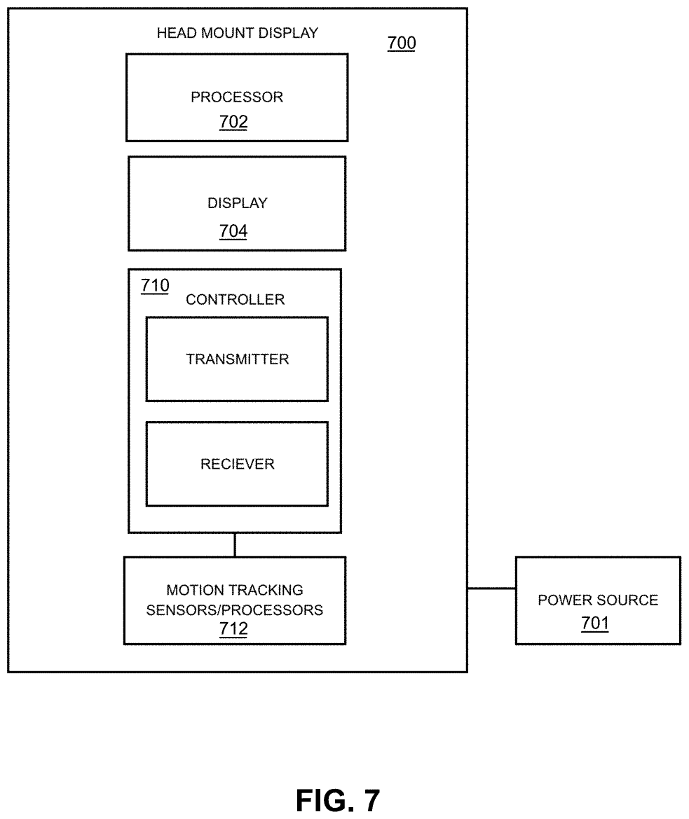

FIG. 7 depicts an exemplary head-mount display device 700 configured to implement the system for providing an immersive educational experience. Head-mount display device 700 may be commercially available or custom made. The head-mount display device 700 may include a processing device (processor) 702, a display 704, a controller 710 having a transmitter and receiver, and a motion tracking sensors/processor 712. Additionally, the head-mount display device 700 may be electronically coupled to a power source 701. The processor 702 may include any custom made or commercially available processor, such as those discussed above. In some embodiments, the head-mount display device 700 may further include an audio emitter (not shown).

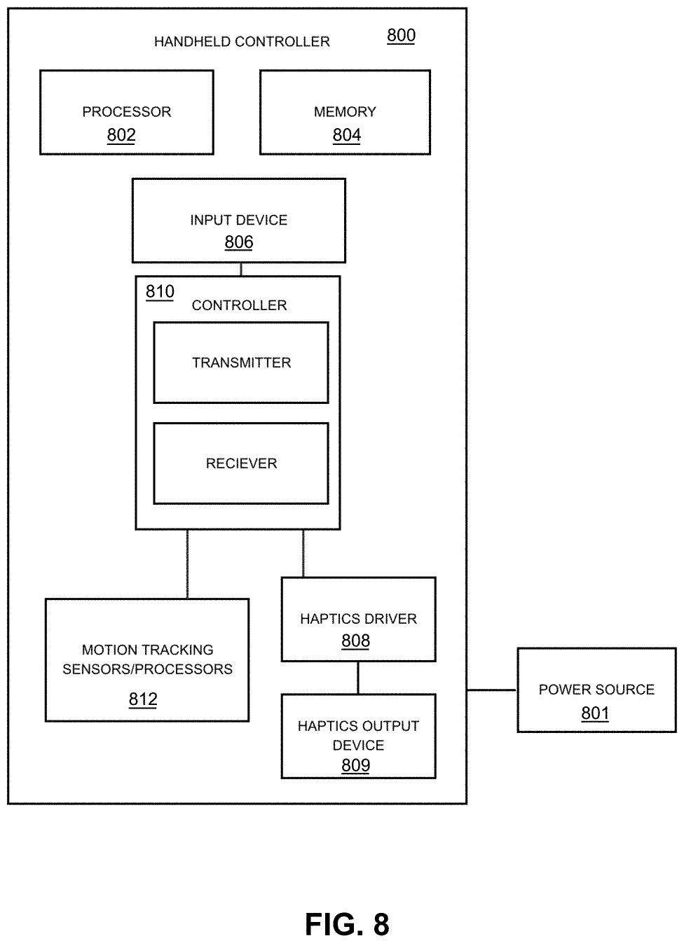

FIG. 8 illustrates an exemplary handheld controller 800 configured to implement the system for providing an immersive educational experience. Handheld controller 800 may be commercially available or custom made and including gamepads, joysticks, or keyboards but may also be embodied in any one of a wide variety of wired and/or wireless handheld gaming controllers known to those skilled in the art. The handheld controller 800 may include a processing device (processor) 802, a memory 804, one or more input devices 806, a controller 810 having a transmitter and receiver, a motion tracking sensors/processor 812, a haptics driver 808 and a haptic output device 809. Additionally, handheld controller 800 may be electronically coupled to a power source 801. The processor 802 may include any custom made or commercially available processor, such as those discussed above. Moreover, the memory 804 may include any one of a combination of volatile memory elements and nonvolatile memory elements, such as those discussed above.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, any multimedia information comprising the system may vary depending on the desired type of educational information. As another example, the number of users may increase from one to as many users as desired. Accordingly, it is intended that the invention not be limited, except as by the appended claims.

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for providing an immersive educational experience with which that terminology is associated. In general, the terms used in the following claims should not be constructed to limit the system and method for providing an immersive educational experience to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for providing an immersive educational experience is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method for providing an immersive educational experience.

What is claimed is:

1. A system for providing an immersive educational experience, comprising
a computing device operative to
store multimedia information, the multimedia information comprising at least one graphical image and audio data, wherein the at least one graphical image is a three-dimensional representation of one or more biological mechanisms;
generate an immersive environment defined by the multimedia information;
transmit output data defined by the immersive environment;
a head-mount display device, configured to be worn on a user's head, and operative to
determine the position and orientation of the user's head;
receive the output data from the computing device;
display the immersive environment according to the position and orientation of the user's head and the output data.

2. The system of claim 1, wherein the one or more biological mechanisms is selected from the group consisting of a cell engulfing a virus, a cell undergoing apoptosis, and a medication shielding the cell from the virus.

3. The system of claim 1, further comprising
a handheld controller operative to measure any physical manipulations of the handheld controller by a user to generate input data; and
wherein the computing device is further operative to
receive input data transmitted by the handheld controller; and
adapt the immersive environment in accordance with the input data.

4. The system of claim 3, wherein the handheld controller comprises one or more input devices operative to
receive physical manipulations by the user; and
alter the actions of the one or more biological mechanisms.

5. The system of claim 1, further comprising one or more sensor stations, wherein the one or more sensor stations are operative to
detect and measure any physical gestures of the user's hands and body to generate input data; and
wherein the computing device is further operative to
receive input data transmitted by the one or more sensor stations; and
adapt the immersive environment in accordance with the input data.

6. The system of claim 1, wherein the head-mount display device further comprises
one or more sensors operative to determine the position and orientation of the user's head;
a visual display, operative to display the at least one graphical image to the user; and
at least one audio emitter, operative to transmit the audio data to the user.

7. A system for providing an immersive educational experience for the purpose of improving medication adherence, comprising
a computing device operative to
store multimedia information, the multimedia information comprising at least one graphical image and audio data, wherein the at least one graphical image is a three-dimensional representation of one or more biological mechanisms;
generate an immersive environment defined by the multimedia information;
transmit output data defined by the immersive environment;
a head-mount display device, configured to be worn on a user's head, and operative to
determine the position and orientation of the user's head;
receive the output data from the computing device; and
display the immersive environment according to the position and orientation of the user's head and the output data.

8. The system of claim 7, wherein the one or more biological mechanisms comprise
a cell engulfing a virus and the cell then undergoing apoptosis, thereby representing a diseased state; and
a pharmaceutical compound being administered and shielding the cell from the virus, thereby representing a medicated state.

9. The system of claim 7, further comprising
a handheld controller operative to measure any physical manipulations of the handheld controller by a user to generate input data; and
wherein the computing device is further operative to
receive input data transmitted by the handheld controller; and
adapt the immersive environment in accordance with the input data.

10. The system of claim 9, wherein the handheld controller comprises one or more input devices operative to
receive physical manipulations by the user; and
alter the actions of the one or more biological mechanisms.

11. The system of claim 7, wherein the head-mount display device further comprises
one or more sensors operative to determine the position and orientation of the user's head; and
a visual display, operative to display the immersive environment to the user; and
at least one audio emitter, operative to transmit the audio data to the user.

12. A method for providing an immersive educational experience, comprising:
providing a computing device and a head-mount display device;
at the computing device,
a) generating an immersive environment defined by multimedia information, comprising at least one graphical image and audio data;
b) transmitting the immersive environment to the head-mount display device configured to be worn by a user;
at the head-mount display device,
a) determining the position and orientation of the user's head; and
b) delivering the immersive environment to the user.

13. The method of claim 12, wherein the at least one graphical image comprises a three-dimensional representation of one or more biological mechanisms.

14. The method of claim 13, wherein the one or more biological mechanisms comprises
one or more physiological agents, the physiological agents being a three-dimensional representation of real-world cells; and
one or more treatment agents, the treatment agents being a three-dimensional representation of real-world pharmaceutical compounds.

15. The method of claim 14, further comprising the steps of
at the computing device, generating
a) the one or more physiological agents comprising a white blood cell;
b) the one or more physiological agents comprising a human immunodeficiency virus (HIV);
at the head-mount display device, displaying
a) the white blood cell engulfing the HIV; and
b) the white blood cell undergoing apoptosis.

16. The method of claim 14, further comprising the steps of
at the computing device, generating
a) the one or more physiological agents comprising a white blood cell;
b) the one or more physiological agents comprising a human immunodeficiency virus (HIV);
c) the one or more treatment agents;
at the head-mount display device, displaying
a) the one or more treatment agents shielding the white blood cell; and
b) the HIV unsuccessfully attempting to attack the white blood cell.

17. The method of claim 12, further comprising
at a handheld controller,
a) receiving and measuring physical manipulations to define input data;
b) transmitting the input data to the computing device;
at the computing device,
a) receiving the input data from the handheld controller; and
b) altering the immersive environment in response to the input data.
